(19) United States
(12) Patent Application Publication
(10) Pub. No.: US 2016/0013730 A1
(43) Pub. Date: Jan. 14, 2016

(54) RECTIFIER CIRCUIT FOR CONVERTING AC VOLTAGE INTO RECTIFIED VOLTAGE

(71) Applicant: SAMSUNG ELECTRONICS CO., LTD., SUWON-SI (KR)

(72) Inventor: FILIPPO NERI, Seongnam-si (KR)

(21) Appl. No.: 14/799,305

(22) Filed: Jul. 14, 2015

(30) Foreign Application Priority Data
Jul. 14, 2014 (KR) 10-2014-0088464

(51) Int. Cl. H02M 7/06; H02M 7/217

(52) U.S. Cl. CPC H02M 7/06; H02M 7/217

(57) ABSTRACT

A rectifier circuit includes a low side switching circuit, a high side switching circuit and a low side driver. The low side switching circuit is connected between a reference node and first and second input nodes. The first and second input nodes receive an alternating current (AC) voltage. The high side switching circuit is connected between an output node and the first and second input nodes. The output node outputs a rectified voltage of the AC voltage. The low side driver is coupled to the low side switching circuit. The low side driver controls, in response to a control signal, the low side switching circuit so that the low side driving voltage and a voltage provided from one of the first and second input nodes are synchronized in phase.

### CROSS-REFERENCE TO RELATED APPLICATION

This application claims priority under 35 U.S.C. §119 to Korean Patent Application No. 10-2014-0088464, filed on Jul. 14, 2014 in the Korean Intellectual Property Office, the disclosure of which is incorporated by reference herein in its entirety.

1. Technical Field

The present inventive concept relates to a rectifier circuit for converting an alternating current (AC) voltage into a rectified voltage.

2. Discussion of Related Art

Portable devices may include a rectifier circuit to obtain a direct current (DC) voltage from an alternating current (AC) voltage. A DC voltage obtained by a rectifier circuit may be used to generate a DC current which is, for instance, used to charge a battery. Charging a battery may be performed in a wireless manner. To increase the power transfer distance in wireless charging, a rectifier circuit is required to have high conversion efficiency from an AC voltage to a DC voltage.

### SUMMARY

According to an exemplary embodiment of the present inventive concept, a rectifier circuit includes a low side switching circuit, a high side switching circuit and a low side driver. The low side switching circuit is connected between a reference node and first and second input nodes. The first and second input nodes receive an alternating current (AC) voltage. The high side switching circuit is connected between an output node and the first and second input nodes. The output node outputs a rectified voltage of the AC voltage. The low side driver is coupled to the low side switching circuit. The low side driver controls, in response to a control signal, the low side switching circuit so that the low side driving voltage and a voltage provided from one of the first and second input nodes are synchronized in phase.

According to an exemplary embodiment of the present inventive concept, a rectifier circuit includes a low side switching circuit, a high side switching circuit, first and second low side drivers, a bootstrap circuit and a high side driver. The low side switching circuit is connected between a reference node and first and second input nodes. The first and second input nodes receive an alternating current (AC) voltage. The high side switching circuit is connected between an output node and the first and second input nodes. The output node outputs a rectified voltage of the AC voltage. The first and second low side drivers are each coupled to the low side switching circuit. The first and second low side drivers are configured to generate low side driving voltages. The first and second low side drivers controls, in response to a control signal, the low side switching circuit so that the low side driving voltages provided from the first and second low side drivers are synchronized with voltages provided from the second and first input nodes, respectively. The bootstrap circuit is coupled to the second input node. The bootstrap circuit is configured to generate a bootstrapping voltage based on a bootstrap driving voltage and the voltage provided from the second input node. The high side driver is coupled to the high side switching circuit. The high side driver provides a high side driving voltage to the high side switching circuit to control the high side switching circuit and generate the high side driving voltage based on at least one of the rectified voltage, the voltages provided from the first and second input nodes, the low side driving voltage generated by the second low side driver, the bootstrap driving voltage, and the bootstrapping voltage.

According to an exemplary embodiment of the present inventive concept, a rectifier circuit is provided. A low side switching circuit is coupled between a reference node and first and second input nodes. The first and second input nodes receive an alternating current (AC) voltage. A high side switching circuit is coupled between an output node and the first and second input nodes. The output node outputs a rectified voltage of the AC voltage. First and second low side drivers are each coupled to the low side switching circuit. The first and second low side drivers generate low side driving voltages. The first and second low side drivers control, in response to a control signal, the low side switching circuit so that the low side driving voltages provided from the first and second low side drivers are synchronized with voltages provided from the second and first input nodes, respectively. A bootstrap driving voltage generator generates a bootstrap driving voltage based on the rectified voltage, the control signal, and an offset voltage. A bootstrap circuit is coupled to the high side switching circuit. The bootstrap circuit generates a bootstrapping voltage based on the low side driving voltage generated by the first low side driver and the bootstrap driving voltage and provides the bootstrapping voltage to the high side switching circuit.

According to an exemplary embodiment of the present inventive concept, a rectifier circuit is provided. First and second input nodes receive an alternating current (AC) voltage. An output node outputs a rectified voltage of the AC voltage. The rectified voltage is represented as a voltage with reference to a reference voltage. A first diode is coupled between the first input node and a reference node. The reference node has the reference voltage. A second diode is coupled between the first diode and the output node. A third diode is coupled between the second input node and the reference node. A fourth diode is coupled between the third diode and the output node. A first transistor is coupled between the first input node and the reference node. A gate terminal of the first transistor is coupled to the second input node. A second transistor is coupled between the second input node and the reference node. A gate terminal of the second transistor is coupled to the first input node.

### BRIEF DESCRIPTION OF THE DRAWINGS

These and other features of the inventive concept will become more apparent by describing in detail exemplary embodiments thereof with reference to the accompanying drawings of which:

FIG. 1 is a schematic diagram illustrating a rectifier circuit according to an exemplary embodiment of the present inventive concept;

FIG. 2 is a graph illustrating waveforms of voltages of input nodes in a rectifier circuit according to an exemplary embodiment of the present inventive concept;

FIG. 3 is a graph illustrating a waveform of a low side driving voltage in a rectifier circuit according to an exemplary embodiment of the present inventive concept;

FIG. 4 is a schematic diagram illustrating a rectifier circuit according to an exemplary embodiment of the present inventive concept;

FIG. 5 is a graph illustrating waveforms of a low side driving voltage and a high side driving voltage in a rectifier circuit according to an exemplary embodiment of the present inventive concept;

FIG. 6 is a schematic diagram illustrating a high side driver of a rectifier circuit of FIG. 4 according to an exemplary embodiment of the present inventive concept;

FIG. 7 is a schematic diagram illustrating a connection between a high side driver of FIG. 6 and other components according to an exemplary embodiment of the present inventive concept;

FIG. 8 is a schematic diagram illustrating a configuration included in a high side driver in a rectifier circuit of FIG. 4 according to an exemplary embodiment of the present inventive concept;

FIG. 9 is a schematic diagram illustrating a high side driver including a configuration of FIG. 8 according to an exemplary embodiment of the present inventive concept;

FIG. 10 is a schematic diagram describing a connection between a high side driver of FIG. 9 and other components according to an exemplary embodiment of the present inventive concept;

FIG. 11 is a schematic diagram illustrating a rectifier circuit according to an exemplary embodiment of the present inventive concept;

FIG. 12 is a block diagram illustrating a receiver of a power transferring system including a rectifier circuit according to an exemplary embodiment of the present inventive concept;

FIG. 13 is a block diagram illustrating a transmitter and a receiver of a power transferring system including a rectifier circuit according to an exemplary embodiment of the present inventive concept; and

FIG. 14 is a block diagram illustrating a power management system of a portable electronic device employing a power transferring system including a rectifier circuit according to an exemplary embodiment of the present inventive concept.

### DETAILED DESCRIPTION OF EMBODIMENTS

Exemplary embodiments of the inventive concept will be described below in detail with reference to the accompanying drawings. However, the inventive concept may be embodied in different forms and should not be construed as limited to the embodiments set forth herein. In the drawings, the thickness of layers and regions may be exaggerated for clarity. It will also be understood that when an element is referred to as being “on” another element or substrate, it may be directly on the other element or substrate, or intervening layers may also be present. It will also be understood that when an element is referred to as being “coupled to” or “connected to” another element, it may be directly coupled to or connected to the other element, or intervening elements may also be present. Like reference numerals may refer to the like elements throughout the specification and drawings.

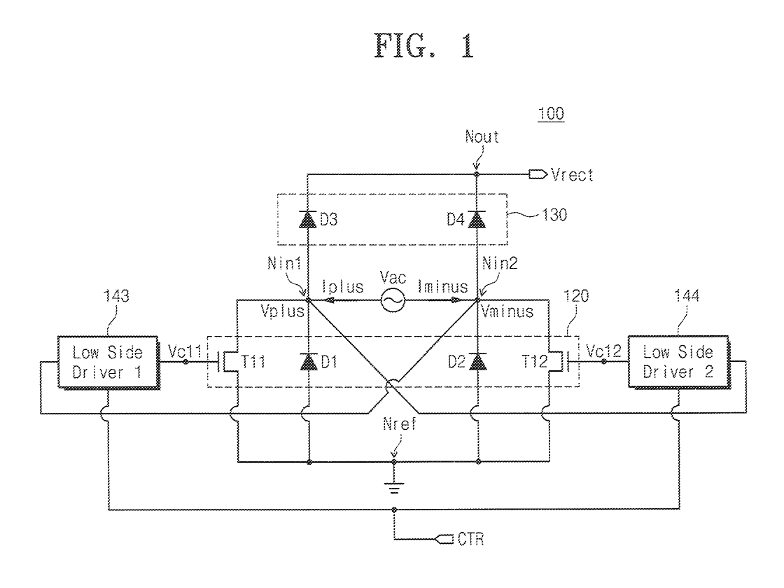

FIG. 1 is a schematic diagram illustrating a rectifier circuit 100 according to an exemplary embodiment of the present inventive concept. The rectifier circuit 100 receives an alternating current (AC) voltage Vac. The rectifier circuit 100 converts the received AC voltage Vac into a rectified voltage Vrect. The rectifier circuit 100 includes a low side switching circuit 120, a high side switching circuit 130, and low side drivers 143 and 144.

Input currents Iplus and Iminus are generated based on the AC voltage Vac, and are provided to input nodes Nin1 and Nin2, respectively, of the rectifier circuit 100. For example, the input current Iplus is provided to the input node Nin1 for a half period of the AC voltage Vac, and thus, the input node Nin I has a voltage Vplus for the half period of the AC voltage Vac. For the other half period of the AC voltage Vac, the input current Iminus is provided to the input node Nin2 so that the input node Nin2 has a voltage Vminus for the other half period of the AC voltage Vac. A phase difference between the voltage Vplus of the input node Nin1 and the voltage Vminus of the input node Nin2 is 180°. Descriptions of waveforms of the voltages Vplus and Vminus of the input nodes Nin1 and Nin2 will be mentioned with reference to FIG. 2.

The low side switching circuit 120 is connected between a reference node Nref and the input nodes Nin1 and Nin2. The reference node Nref is grounded, but the present inventive concept is not limited thereto. The low side switching circuit 120 includes switching transistors T11 and T12 and diodes D1 and D2. The transistor T11 and the diode D1 are connected in parallel between the reference node Nref and the input node Nin1, and the transistor T12 and the diode D2 are connected in parallel between the reference node Nref and the input node Nin2.

The high side switching circuit 130 be connected between the input nodes Nin1 and Nin2 and an output node Nout. As an example embodiment, the high side switching circuit 130 include diodes D3 and D4. In this example embodiment, an anode of the diode D3 be connected to the input node Nin1 and a cathode of the diode D3 be connected to the output node Nout. Further, an anode of the diode D4 be connected to the input node Nin2 and a cathode of the diode D4 be connected to the output node Nout.

The AC voltage Vac is converted into the rectified voltage Vrect by the diodes D1 and D2 and the switching transistors T11 and T12, which are included in the low side switching circuit 120, and the diodes D3 and D4, which are included in the high side switching circuit 130. The rectified voltage Vrect is outputted from the output node Nout. The low side switching circuit 120 is controlled by the low side drivers 143 and 144.

The low side driver 143 receives the voltage Vminus of the input node Nin2, and outputs a low side driving voltage Vc11. The low side driving voltage Vc11 and the voltage Vminus are synchronized in phase. The low side driving voltage Vc11 is provided to the low side switching circuit 120. The low side driver 143 operates in response to a control signal CTR. The control signal CTR may have a voltage generated by a programmable linear regulator, but the present inventive concept is not limited thereto. For instance, the control signal CTR may have a fixed voltage value.

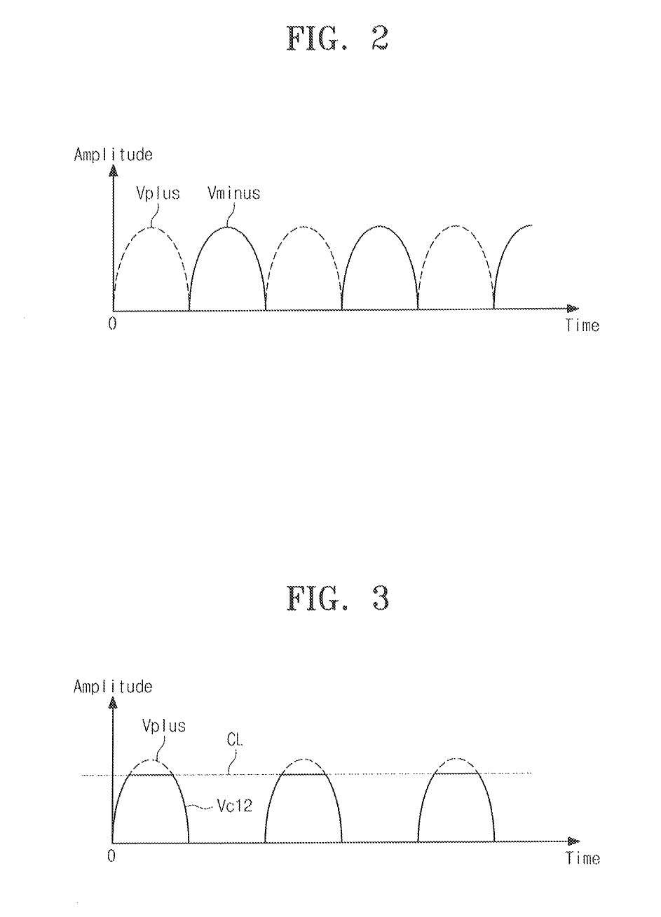

The low side driver 144 receives the voltage Vplus of the input node Nin1, and outputs a low side driving voltage Vc12. The low side driving voltage Vc12 and the voltage Vplus are synchronized in phase. The low side driving voltage Vc12 is provided to the low side switching circuit 120. The low side driver 144 operates in response to the control signal CTR. The low side driving voltages Vc11 and Vc12 will be described with reference to FIG. 3.

The low side driving voltage Vc11 is provided to a gate terminal of the switching transistor T11, and the low side driving voltage Vc12 is provided to a gate terminal of the switching transistor T12.

FIG. 2 illustrates waveforms of voltages Vplus and Vminus of input nodes Nin1 and Nin2 of FIG. 1, respectively, in a rectifier circuit according to an exemplary embodiment of the present inventive concept. A horizontal axis of the graph of FIG. 2 denotes time. A vertical axis of the graph of FIG. 2 denotes amplitude of a voltage.

In FIG. 2, a waveform of the voltage Vplus of the input node Nin1 is represented by a broken line, and a waveform of the voltage Vminus of the input node Nin2 is represented by a solid line. As described with reference to FIG. 1, the input node Nin1 has the voltage Vplus corresponding to a half period of the AC voltage Vac, and the input node Nin2 has the voltage Vminus corresponding to the other half period of the AC voltage Vac. The four diodes D1 to D4 in a bridge configuration serves as a full-wave rectifier, converting the whole of the AC voltage Vac to constant, positive polarity as its output. As illustrated in FIG. 2, each of the voltage Vplus of the input node Nin1 and the voltage Vminus of the input node Nin2 has an amplitude component, in turn, during a time interval corresponding to a half period of the AC voltage Vac.

For the convenience of description, the waveforms of FIG. 2 are presented, and the present inventive concept is not limited thereto. The voltages Vplus and Vminus of the input nodes Nin1 and Nin2 have different waveforms from those illustrated in FIG. 2.

FIG. 3 illustrates a waveform of low side driving voltage Vc12 of FIG. 1 according to an exemplary embodiment of the present inventive concept. A horizontal axis of the graph of FIG. 3 denotes time. A vertical axis of the graph of FIG. 3 denotes amplitude of a voltage.

In, FIG. 3 a relation between a voltage Vplus of an input node Nin1 (refer to FIG. 1) and the low side driving voltage Vc12 outputted from the low side driver 144 (refer to FIG. 1) is shown. The waveform of the voltage Vplus of the input node Nin1 is represented by a broken line. As described with reference to FIGS. 1 and 2, the input node Nin1 has the voltage Vplus corresponding to a half period of an AC voltage Vac.

The waveform of the low side driving voltage Vc12 is represented by a solid line. The low side driving voltage Vc12 and the voltage Vplus of the input node Nin1 are synchronized in phase. The low side driving voltage Vc12 has a waveform of which amplitude is cut off by the maximum gate voltage CL allowed by the switching transistor T12 (refer to FIG. 1) of the low side switching circuit 120 (refer to FIG. 1).

For the convenience of description, the waveforms of FIG. 3 are presented herein, and the present inventive concept is not limited thereto. For example, the voltage Vplus of the input node Nin1 and the low side driving voltage Vc12 may have different waveforms from those illustrated in FIG. 3.

Although not illustrated in FIG. 3, a voltage Vminus (refer to FIG. 1) of an input node Nin2 (refer to FIG. 1) and a low side driving voltage Vc11 (refer to FIG. 1) outputted from a low side driver 143 (refer to FIG. 1) may have similar waveforms to the voltage Vplus of the input node Nin1 and the low side driving voltage Vc12 outputted from the low side driver 144, respectively. For instance, by moving the voltage Vplus and the low side driving voltage Vc12 along a time axis, the voltage Vminus and the low side driving voltage Vc11 may be obtained. Accordingly, detailed descriptions of a relation between the voltage Vminus and the low side driving voltage Vc11 will be omitted.

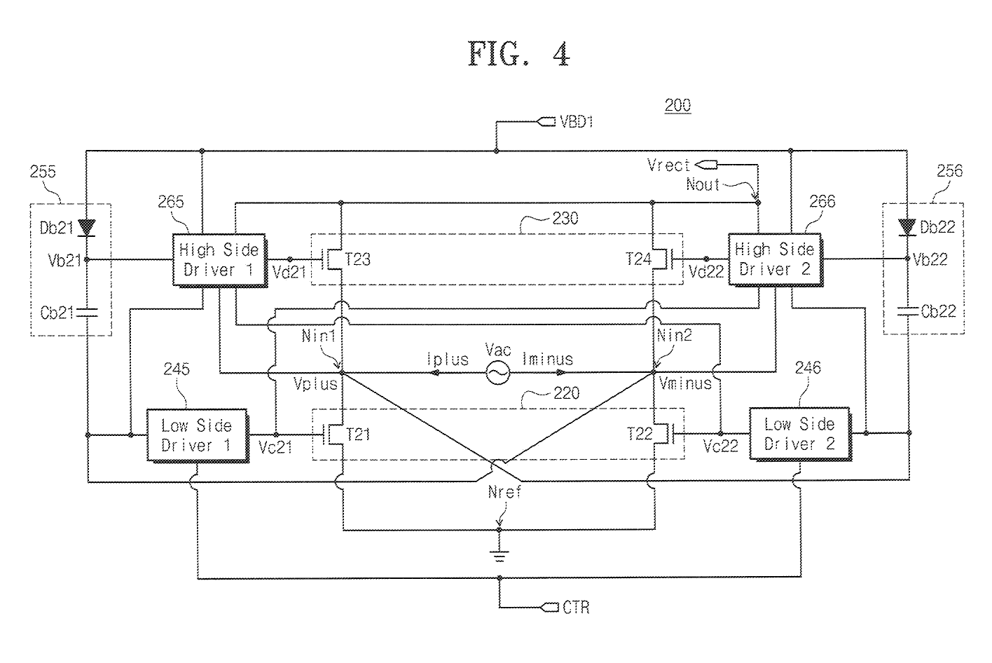

FIG. 4 is a schematic diagram illustrating a rectifier circuit 200 according to an exemplary embodiment of the present inventive concept. The rectifier circuit 200 receives an AC voltage Vac. The rectifier circuit 200 converts the received AC voltage Vac into a rectified voltage Vrect. The rectifier circuit 200 includes a low side switching circuit 220, a high side switching circuit 230, low side drivers 245 and 246, bootstrap circuits 255 and 256, high side drivers 265 and 266.

Input currents Iplus and Iminus are generated based on the AC voltage Vac, and are provided to input nodes Nin1 and Nin2, respectively, of the rectifier circuit 200. For example, for a half period of the AC voltage Vac, the input current Iplus is provided to the input node Nin1. Accordingly, the input node Nin1 has a voltage Vplus corresponding to the half period of the AC voltage Vac. For the other half period of the AC voltage Vac, the input current Iminus is provided to the input node Nin2. Accordingly, the input node Nin2 has a voltage Vminus corresponding to the other half period of the AC voltage Vac. The phase difference of the voltage Vplus of the input node Nin1 and the voltage Vminus of the input node Nin2 may be 180°. Descriptions of waveforms of the voltages Vplus and Vminus of the input nodes Nin1 and Nin2 have been made with reference to FIG. 2.

The low side switching circuit 220 is connected between a reference node Nref and the input nodes Nin1 and Nin2. The reference node Nref is grounded, but the present inventive concept is not limited thereto. The low side switching circuit 220 includes low side transistors T21 and T22. The low side transistors T21 and T22 are n-channel metal oxide semiconductor (NMOS) transistors. One terminal of the low side transistor T21 is connected to the reference node Nref, and the other terminal of the low side transistor T21 is connected to the input node Nin1. Further, one terminal of the low side transistor T22 is connected to the reference node Nref, and the other terminal of the low side transistor T22 is connected to the input node Nin2.

The high side switching circuit 230 is connected between the input nodes Nin1 and Nin2 and an output node Nout. The high side switching circuit 230 includes high side transistors T23 and T24. The high side transistors T23 and T24 are NMOS transistors. One terminal of the high side transistor T23 is connected to the input node Nin1, and the other terminal of the high side transistor T23 is connected to the output node Nout. Further, one terminal of the high side transistor T24 is connected to the input node Nin2, and the other terminal of the high side transistor T24 is connected to the output node Nout.

The AC voltage Vac is converted into the rectified voltage Vrect by a circuit including the low side transistors T21 and T22, which are included in the low side switching circuit 220, and the high side transistors T23 and T24, which are included in the high side switching circuit 230. The rectified voltage Vrect is outputted from the output node Nout. The low side switching circuit 220 is controlled by the low side drivers 245 and 246, and the high side switching circuit 230 is controlled by the high side drivers 265 and 266.

The low side driver 245 receives the voltage Vminus of the input node Nin2, and outputs a low side driving voltage Vc21. The low side drive voltage Vc21 and the voltage Vminus of the input node Nin2 are synchronized in phase. The low side driving voltage Vc21 is provided to the low side switching circuit 220. The low side driver 245 operates in response to a control signal CTR. The control signal CTR may have a voltage generated by a programmable linear regulator, but the present inventive concept is not limited thereto. The control signal CTR may have a fixed voltage value.

The low side driver 246 receives the voltage Vplus of the input node Nin1, and outputs a low side driving voltage Vc22. The low side driving voltage Vc22 and the voltage Vplus of the input node Nin1 are synchronized in phase. The low side driving voltage Vc22 is provided to the low side switching circuit 220. The low side driver 246 operates in response to the control signal CTR. Descriptions of waveforms of the low side driving voltages Vc21 and Vc22 have been made with reference to FIG. 3.

The low side switching circuit 220 includes the low side transistors T21 and T22. The low side driving voltage Vc21 is provided to a gate terminal of the low side transistor T21, and the low side driving voltage Vc22 is provided to a gate terminal of the low side transistor T22.

The bootstrap circuits 255 and 256 generate bootstrapping voltages Vb21 and Vb22. For example, the bootstrap circuit 255 outputs the bootstrapping voltage Vb21 generated based on a bootstrap driving voltage VBD1 and the voltage Vminus of the input node Nin2, and the bootstrap circuit 256 outputs the bootstrapping voltage Vb22 generated based on the bootstrap driving voltage VBD1 and the voltage Vplus of the input node Nin1. The bootstrap driving voltage VBD1 may have a voltage generated by a programmable linear regulator, but the present inventive concept is not limited thereto. The bootstrap driving voltage VBD1 may have a fixed voltage value.

The bootstrap circuit 255 includes a diode Db21 and a capacitor Cb21. The diode Db21 and the capacitor Cb21 are connected in series between a node for receiving the bootstrap driving voltage VBD1 and the input node Nin2. For example, an anode of the diode Db21 is connected to the node for receiving the bootstrap driving voltage VBD1, and one terminal of the capacitor Cb21 is connected to the input node Nin2. Further, a cathode of the diode Db21 is connected to the other terminal of the capacitor Cb21. The bootstrapping voltage Vb21 corresponds to a voltage of a node at which the diode Db21 and the capacitor Cb21 are connected to each other.

The bootstrap circuit 256 includes a diode Db22 and a capacitor Cb22. The diode Db22 and the capacitor Cb22 are connected in series between the node for receiving the bootstrap driving voltage VBD1 and the input node Nin1. For example, an anode of the diode Db22 is connected to the node for receiving the bootstrap driving voltage VBD1, and one terminal of the capacitor Cb22 is connected to the input node Nin1. Further, a cathode of the diode Db22 is connected to the other terminal of the capacitor Cb22. The bootstrapping voltage Vb22 corresponds to a voltage of a node at which the diode Db22 and the capacitor Cb22 are connected to each other.

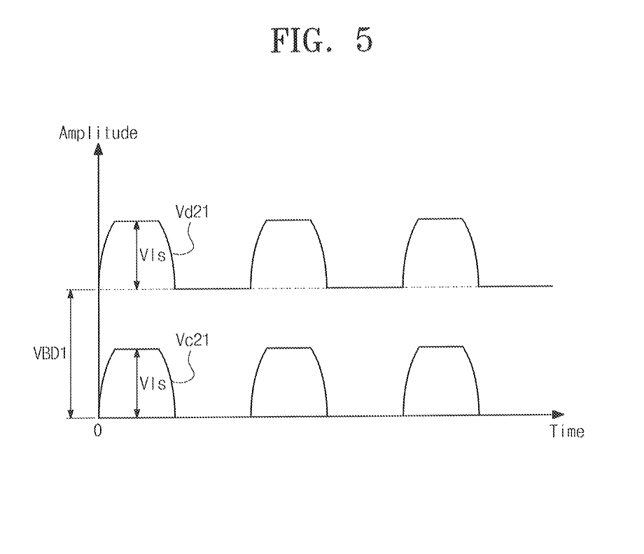

The high side drivers 265 and 266 generate high side driving voltages Vd21 and Vd22. The high side driving voltages Vd21 and Vd22 are provided to the high side switching circuit 230. The waveforms of the high side driving voltages Vd21 and Vd22 may correspond to bootstrapped waveforms of the low side driving voltage Vc21 and Vc22, respectively. Descriptions of a relation between the high side driving voltages Vd21 and Vd22 and the low side driving voltage Vc21 and Vc22 will be made with reference to FIG. 5.

The high side driver 265 generates the high side driving voltage Vd21 based on at least one of the rectified voltage Vrect, the voltage Vminus, the low side driving voltage Vc22, the bootstrap driving voltage VBD1, and the bootstrapping voltage Vb21. In this case, a wire or line corresponding to a voltage not being used to generate the high side driving voltage Vd21 from among the rectified voltage Vrect, the voltages Vplus and Vminus respectively provided from the input nodes Nin1 and Nin2, the low side driving voltage Vc22, the bootstrap driving voltage VBD1, and the bootstrapping voltage Vb21 need not be provided or may be floated. Alternatively, the high side driver 265 further include a control circuit (not shown) for controlling a connection of a wire or line being used to generate the high side driving voltage Vd21 and a connection of the wire or line not being used to generate the high side driving voltage Vd21. The high side driver 265 provides the high side driving voltage Vd21 to the high side switching circuit 230. The high side switching circuit 230 includes the high side transistor T23, and the high side driving voltage Vd21 is provided to a gate terminal of the side transistor T23.

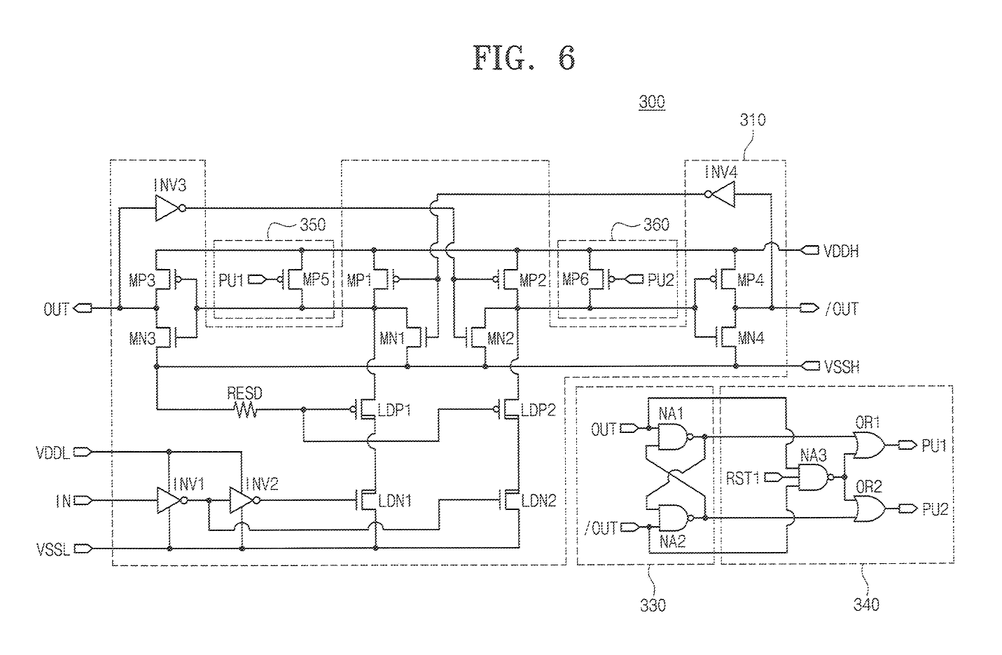

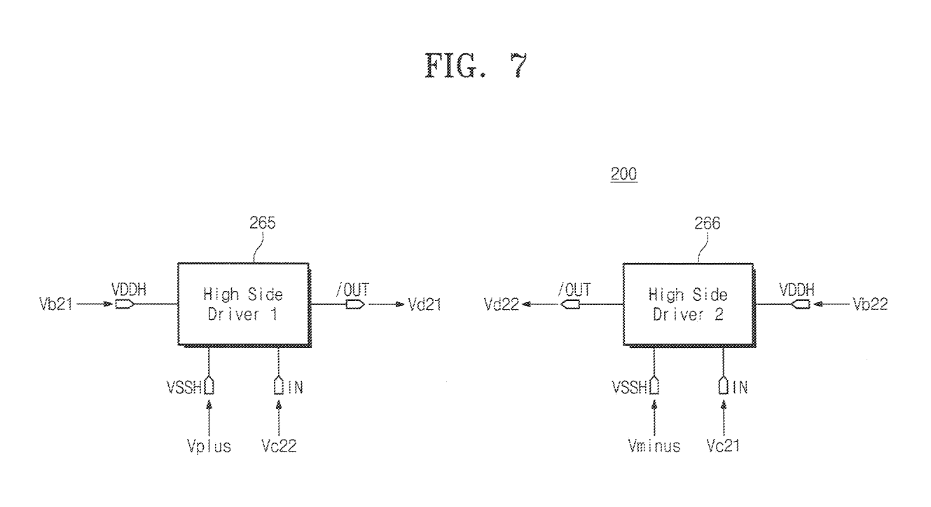

The high side driver 266 generates the high side driving voltage Vd22 based on at least one the rectified Vrect, the voltage Vplus, the low side driving voltage Vc21, the bootstrap driving voltage VBD1, and the bootstrapping voltage Vb22. In this case, if a voltage is not used to generate the high side driving voltage Vd22, such unused voltage need not be provided to the high side driver or a wire or line supplying the unused voltage may be floated. Alternatively, the high side driver 266 may further include a control circuit (not shown) for controlling a connection of a wire or line being used to generate the high side driving voltage Vd22 and a connection of the wire or line not being used to generate the high side driving voltage Vd22. The high side driver 266 provides the high side driving voltage Vd22 to the high side switching circuit 230. The high side switching circuit 230 includes the high side transistor T24, and the high side driving voltage Vd22 is provided to a gate terminal of the side transistor T24. Descriptions of the high side driver 265 and 266 will be made with reference to FIGS. 6 to 10.

FIG. 5 illustrates waveforms of a low side driving voltage Vc21 and a high side driving voltage Vd21 in a rectifier circuit according to an exemplary embodiment of the present inventive concept. A horizontal axis of the graph of FIG. 5 denotes time. A vertical axis of the graph of FIG. 5 denotes amplitude of a voltage.

As shown in FIG. 3, the low side driving voltage Vc21 has a waveform of which amplitude is cut off by the maximum gate voltage of the switching transistor T21 (refer to FIG. 4) in the low side switching circuit 220 (refer to FIG. 4).

As described with reference to FIG. 4, a waveform of the high side driving voltage Vd21 has a bootstrapped waveform of the low side driving voltage Vc21. For example, the high side driving voltage Vd21 is a bootstrapped voltage of the low side driving voltage Vc21 by the bootstrap driving voltage VBD1. For example, the maximum amplitude of the high side driving voltage Vd21 is a value obtained by adding a value of the maximum amplitude Vls of the low side driving voltage Vc21 to a value of the bootstrap driving voltage VBD1.

For the convenience of description, the waveforms of FIG. 5 are presented, and the present inventive concept is not limited thereto. For example, the low side driving voltage Vc21 and the high side driving voltage Vd21 may have different waveforms from those illustrated in FIG. 5.

Although not illustrated in FIG. 5, a low side driving voltage Vc22 (refer to FIG. 4) and a high side driving voltage Vd22 (refer to FIG. 4) may have similar waveforms to the low side driving voltage Vc21 and the high side driving voltage Vd21, respectively. For example, by moving the low side driving voltage Vc21 and the high side driving voltage Vd21 along a time axis, the low side driving voltage Vc22 and the high side driving voltage Vd22 may be obtained. Detailed descriptions of a relation between the low side driving voltage Vc22 and the high side driving voltage Vd22 will be omitted.

According to an exemplary embodiment of the present inventive concept, power loss due to a switching may be reduced. Further, the rectifier circuit according to the example embodiments described in FIGS. 1 to 5 may process a signal having a high frequency of more than several megahertz (MHz). According to the example embodiments of the present inventive concept, a rectifier circuit having high conversion efficiency may be obtained.

FIG. 6 is a schematic diagram illustrating a high side driver 265 or 266 in a rectifier circuit 200 of FIG. 4 according to an exemplary embodiment of the present inventive concept. The high side driver 265 and 266 include a high side driver 300 illustrated in FIG. 6. The high side drive unit 300 includes a level shifter 310, a latch 330, a pull-up signal generator 340, and pull-up circuits 350 and 360.

The level shifter 310 shifts a level of an input signal IN. In the level shifter 310, four driving voltages VDDH, VSSH, VDDL and VSSL are provided. The level of the input signal IN is shifted by a circuit including four inverters INV1, INV2, INV3 and INV4, four p-channel metal oxide semiconductor (PMOS) transistors MP1, MP2, MP3 and MP4, four NMOS transistors MN1, MN2, MN3 and MN4, two p-type lateral double diffused metal oxide semiconductor (LDMOS) transistors LDP1 and LDP2, two n-type LDMOS transistors LDN1 and LDN2, and an electrostatic detection resistance RESD. Operations of the level shifter 310 illustrated in FIG. 6 is well known, thus, detailed descriptions of the level shifter 310 will be omitted. The level shifter 310 is presented for the convenience of description, and the present inventive concept is not limited thereto. For example, the level shifter 310 may have a different configuration from that illustrated in FIG. 6. The level shifter 310 shifts the level of the input signal IN to output output signals OUT and /OUT.

The latch 330 latches the output signals OUT and /OUT of the level shifter 310. The output signals OUT and /OUT is latched by a circuit including two NAND gates NA1 and NA2. Operations of the latch 330 are well known, and thus detailed descriptions of the latch 330 will be omitted. The latch 330 is presented for the convenience of description, and the present inventive concept is not limited thereto. The latch 330 may have a different configuration from that illustrated in FIG. 6. The latch 330 may serve to compensate difference in signal flight time of the two output signals OUT and /OUT.

The pull-up signal generator 340 generates pull-up signals PU1 and PU2 based on the latched output signal of the latch 330 and the output signals OUT and /OUT. A NAND gate NA3 included in the pull-up signal generator 340 performs a NAND logical operation on the output signals OUT and /OUT and a reset signal RST1. If the reset signal RST1 has logic ‘0’, a pull-up signal is triggered. For example, if the reset signal RST1 has logic ‘0’, the pull-up signals PU1 and PU2 are generated according to the latched output signals of the latch 330. An OR gate OR1 performs an OR logical operation on an output of the NAND gate NA3 and the latched output signal OUT to generate the pull-up signal PU1. An OR gate OR2 performs an OR logical operation on the output of the NAND gate NA3 and the latched output signal /OUT to generate the pull-up signal PU2.

The pull-up circuit 350 may cause the level shifter 310 to output the driving voltage VDDH as the output signal OUT in response to the pull-up signal PU1. For example, the pull-up circuit 350 includes a PMOS transistor MPS. For example, when the output signal OUT needs to have the driving voltage VDDH or a voltage near the driving voltage VDDH, a pull-up transistor MP3 is controlled to supply the driving voltage VDDH to an output of an inverter formed of two transistors MP3 and MN3.

The pull-up circuit 360 causes the level shifter 310 to output the driving voltage VDDH as the output signal /OUT in response to the pull-up signal PU2. The pull-up circuit 360 includes a PMOS transistor MP6. For example, when the output signal /OUT needs to have the driving voltage VDDH or a voltage near the driving voltage VDDH, a pull-up transistor MP4 is controlled to supply the driving voltage VDDH to an output of an inverter formed of two transistors MP4 and MN4.

The high side driver 300 is included in the rectifier circuit 200 as the high side driver 265 or 266 of FIG. 4. However, the high side driver 300 serve as a level shift circuit separately provided from the rectifier circuit 200 of the present inventive concept. For example, the high side driver 300, if not included in the rectifier circuit 200, may serve as a level shift circuit.

FIG. 7 is a schematic diagram illustrating a configuration of high side drivers 265 and 266 of FIG. 4. High side drivers 265 and 266 of the rectifier circuit 200 of FIG. 4 are illustrated in FIG. 7. The high side drivers 265 and 266 of the rectifier circuit 200 may include the high side driver 300 of FIG. 6.

Referring to FIGS. 4, 6 and 7, the high side driver 265 generates the high side driving voltage Vd21 based on the voltage Vplus, the low side driving voltage Vc22, and the bootstrapping voltage Vb21. The bootstrapping voltage Vb21 is provided as the driving voltage VDDH. The voltage Vplus is provided as the driving voltage VSSH. The low side driving voltage Vc22 is provided as the input signal IN. The high side driving voltage Vd21 is outputted as the output signal /OUT.

The high side driving voltage Vd21 is generated as the output signal /OUT by shifting a level of the low side driving voltage Vc22 provided as the input signal IN. For example, the pull-up circuit 360 (refer to FIG. 6) included in the high side driver 265 causes the high side driving voltage Vd21 to have the bootstrapping voltage Vb21 in response to a pull-up signal PU2 (refer to FIG. 6). For example, a driving voltage VDDL (refer to FIG. 6) is a voltage having a fixed voltage such as 3V, 4V or 5V, and a driving voltage VSSL (refer to FIG. 6) is a ground voltage. However, the present inventive concept is not limited thereto. Further, in this example embodiment, wires or lines corresponding to a rectified voltage Vrect, a voltage Vminus provided from an input node Nin2, and a bootstrap driving voltage VBD1, which are not used to generate the high side driving voltage Vd21, need not be provided or may be floated. Alternatively, the high side driver 265 may further include a control circuit (not shown) for controlling connections of wires or lines being used to generate the high side driving voltage Vd21 and connections of the wires or lines not being used to generate the high side driving voltage Vd21.

The high side driver 266 generates a high side driving voltage Vd22 based on the voltage Vminus provided from the input node Nin2, a low side driving voltage Vc21, and a bootstrapping voltage Vb22. The high side driver 266 of FIG. 4 includes the high side driver 300 of FIG. 6. The bootstrapping voltage Vb22 is provided as a driving voltage VDDH. The voltage Vminus provided from the input node Nin2 is provided as a driving voltage VSSH. The low side driving voltage Vc21 is provided as an input signal IN. Further, the high side driving voltage Vd22 is output as an output signal /OUT.

The high side driving voltage Vd22 is generated as the output signal /OUT by shifting a level of the low side driving voltage Vc21 provided as the input signal IN. For example, the pull-up circuit 360 included in the high side driver 266 causes the high side driving voltage Vd22 to have the bootstrapping voltage Vb22 in response to the pull-up signal PU2. For example, a driving voltage VDDL is a voltage having a fixed voltage such as 3V, 4V or 5V, and a driving voltage VSSL is a ground voltage. However, the present inventive concept is not limited thereto. Further, in this example embodiment, wires or lines corresponding to the rectified voltage Vrect, the voltage Vplus provided from the input node Nin1, and the bootstrap driving voltage VBD1, which are not used to generate the high side driving voltage Vd22, need not be provided or may be floated. Alternatively, the high side driver 266 may further include a control circuit (not shown) for controlling connections of wires or lines being used to generate the high side driving voltage Vd22 and connections of the wires or lines not being used to generate the high side driving voltage Vd22.

In the high side driver 300 of FIGS. 6 and 7, a voltage change of the output signals OUT and /OUT may be rapidly controlled by the pull-up signals PU1 and PU2 and the pull-up circuits 350 and 360. Accordingly, a response speed of the high side driver 265 and 266 may become faster. When each of the high side drivers 265 and 266 of the rectifier circuit 200 include the high side driver 300 of FIG. 6, the rectifier circuit 200 may have high conversion efficiency.

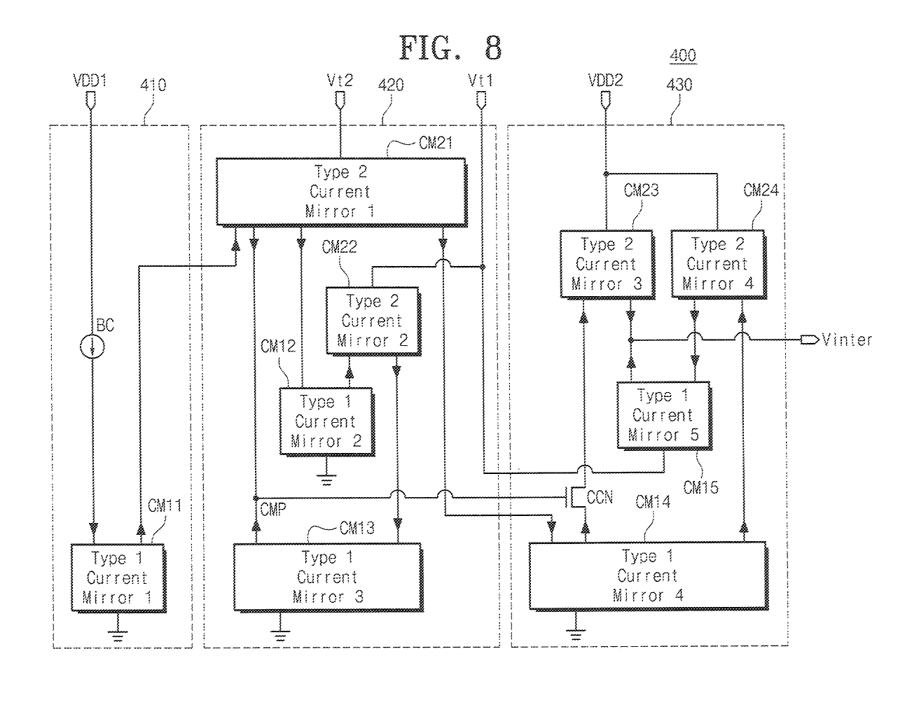

FIG. 8 is a schematic diagram illustrating a high side driver 265 or 266 in a rectifier circuit 200 of FIG. 4. The high side drivers 265 and 266 include a high side driver 400 illustrated in FIG. 8. The high side driver 400 includes a bias current generator 410, a current mode comparator 420, and a level shifter 430.

The bias current generator 410 receives a driving voltage VDD1. A bias current BC is generated in the bias current generator 410. The bias current BC is provided to the current mode comparator 420. The bias current generator 410 includes a first-type first current mirror CM11.

The first-type first current mirror CM11 provides the bias current BC to the current mode comparator 420. The first-type first current mirror CM11 may be an NMOS type current mirror that operates using a ground voltage. A configuration of a current mirror is well known to those of ordinary skilled in the art. Thus, detailed descriptions of the current mirror CM11 will be omitted.

The current mode comparator 420 generates a comparison signal CMP corresponding to a comparison result of amplitude of a first comparison target voltage Vt1 and a second comparison target voltage Vt2. For example, the comparison signal CMP is generated from the comparison result of amplitude of the first comparison target voltage Vt1 and the second comparison target voltage Vt2. The current mode comparator 420 generates the comparison signal CMP by using the bias current BC provided from the bias current generator 410. The current mode comparator 420 includes a second-type first current mirror CM21, a first-type second current mirror CM12, a second-type second current mirror CM22, and a first-type third current mirror CM13.

The second-type first current mirror CM21 outputs current provided from the first-type first current mirror CM11. The second-type first current mirror CM21 is a PMOS type current mirror that operates using the second comparison target voltage Vt2. The first-type second current mirror CM12 outputs current provided from the second-type first current mirror CM21. The first-type second current mirror CM12 may be an NMOS type current mirror. The second-type second current mirror CM22 outputs current provided from the first-type second current mirror CM12. The second-type second current mirror CM22 may be a PMOS type current mirror that operates using the first comparison target voltage Vt1. The first-type third current mirror CM13 outputs current provided from the second-type second current mirror CM22. The first-type third current mirror CM13 may be an NMOS type current mirror that operates using the ground voltage. Using such arrangements of the current mirrors CM21, CM22, CM12 and CM13, the comparison signal CMP is generated based on the current outputted from the second-type first current mirror CM21 and current outputted from the first-type third current mirror CM13. The comparison signal CMP is generated depending on the comparison result of amplitude of the first comparison target voltage Vt1 and the second comparison target voltage Vt2.

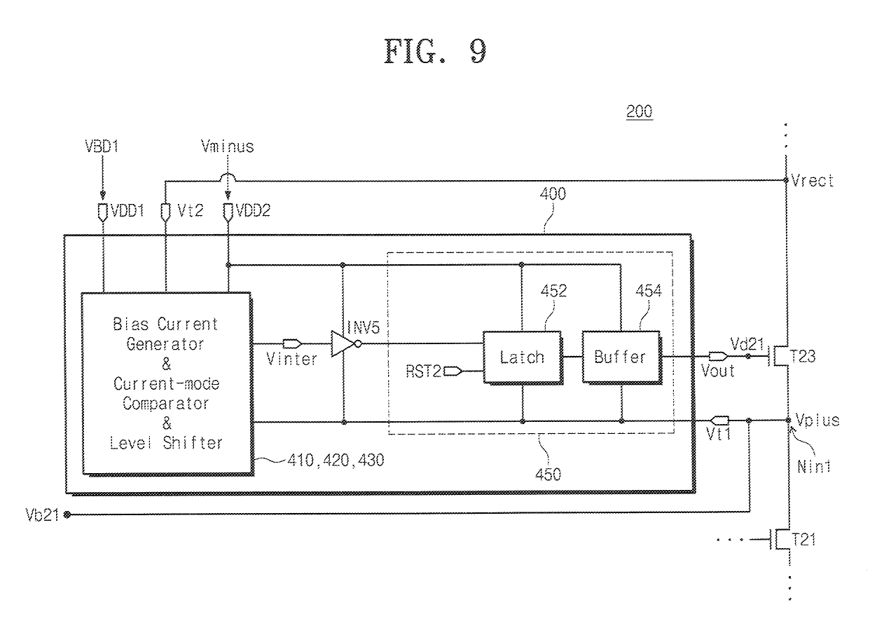

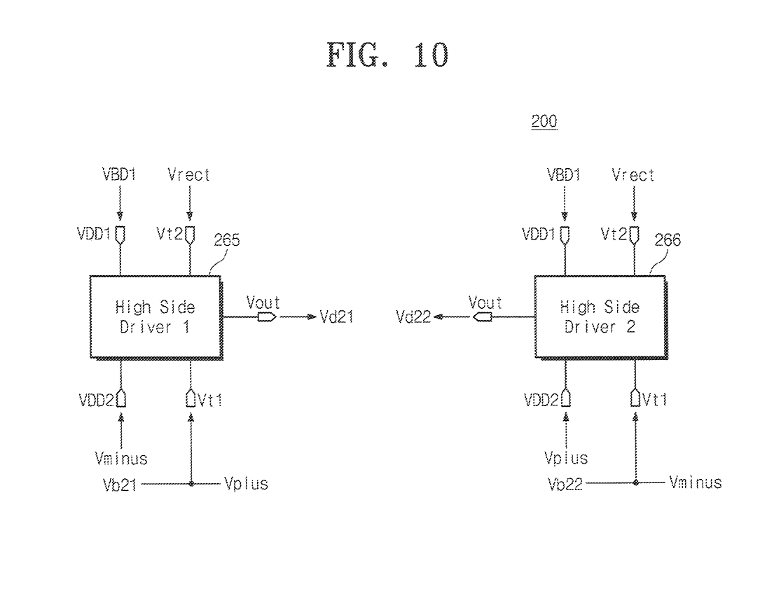

The level shifter 430 generates an intermediate signal Vinter. The intermediate signal Vinter is generated based on the comparison signal CMP. Descriptions of the intermediate signal Vinter will be described with reference to FIG. 9. The level shifter 430 includes a first-type fourth current mirror CM14, a comparison control transistor CCN, a second-type third current mirror CM23, a second-type fourth current mirror CM24, and a first-type fifth current mirror CM15.

The first-type fourth current mirror CM14 outputs current provided from the second-type first current mirror CM21. The first-type fourth current mirror CM14 may be an NMOS type current mirror. The comparison control transistor CCN receives the comparison signal CMP from the current mode comparator 420. The comparison signal CMP is provided to a gate terminal of the comparison control transistor CCN. The comparison control transistor CCN receives current outputted from the first-type fourth current mirror CM14 through its one terminal. The comparison control transistor CCN controls flowing of the received current according to the comparison signal CMP. The comparison control transistor CCN is an NMOS transistor. The second-type third current mirror CM23 outputs current provided from the comparison control transistor CCN. The second-type third current mirror CM23 may be a PMOS type current mirror. The second-type fourth current mirror CM24 outputs current provided from the first-type fourth current mirror CM14. The second-type fourth current mirror CM24 may be a PMOS type current mirror that operates using the drive voltage VDD2. The first-type fifth current mirror CM15 outputs current provided from the second-type fourth current mirror CM24. The first-type fifth current mirror CM15 may be an NMOS type current mirror that operates using the first comparison target voltage Vt1. Using such arrangements of the current mirrors CM23, CM24, CM15 and CM14, the intermediate signal Vinter is generated based on current outputted from the second-type third current mirror CM23 and current outputted from the first-type fifth current mirror CM15. In this case, the current outputted from the second-type third current mirror CM23 may be greater than the current outputted from the first-type fifth current mirror CM15. Accordingly, the intermediate signal Vinter is a shifted level.

The high side driver 400 may be included in the rectifier circuit 200 as the high side driver 265 or 266 of the present inventive concept. However, the high side driver 400, if not used in the rectifier circuit 200 of FIG. 2, may serve as a level shifter. For example, the high side driver 400 illustrated in FIG. 8 may be used as a level shifter for generating the signal Vinter having a different voltage value depending on the comparison result of amplitude of the first comparison target voltage Vt1 and the second comparison target voltage Vt2.

FIG. 9 is a schematic diagram illustrating a part of a rectifier employing a high side driver 400 of FIG. 8 according to an exemplary embodiment of the present inventive concept. In this case, the high side driver 400 further includes an inverter INV5 and an output circuit 450. A node having a bootstrapping voltage Vb21 and an input mode Nin1 is connected to each other.

Referring to FIGS. 4, 8 and 9, the bias current generator 410 receives a bootstrap driving voltage VBD1, and generates a bias current BC (refer to FIG. 8). For example, the bootstrap driving voltage VBD1 is provided as a driving voltage VDD1. The current mode comparator 420 generates a comparison signal CMP (refer to FIG. 8) based on a comparison result of amplitudes of the voltage Vplus and the rectified voltage Vrect. The voltage Vplus provided from the input node Nin1 is provided as the first comparison target voltage Vt1, and the rectified voltage Vrect is provided as the second comparison target voltage Vt2. The voltage Vminus provided from an input node Nin2 (refer to FIG. 4) is provided as the driving voltage VDD2.

The intermediate signal Vinter generated by the level shifter 430 is used to generate a high side driving voltage Vd21. The intermediate signal Vinter is inverted through the inverter INV5. For example, the inverter INV5 inverts the intermediate signal Vinter.

The inverted intermediate signal Vinter is outputted as an output voltage Vout through the output circuit 450. The output voltage Vout is provided to a high side transistor T23 as the high side driving voltage Vd21. The output circuit 450 includes a latch 452 and a buffer 454. The latch 452 is connected to prevent a shoot-through current from flowing through the high side transistor T23. The operations of the latch 452 are controlled according to a reset signal RST2. The reset signal RST2 may have a level obtained by shifting a level of a voltage for controlling a low side transistor T21. The buffer 454 buffers an output of the latch 452 to output the output voltage Vout.

FIG. 10 is a schematic diagram illustrating a configuration of a high side driver 400 of FIG. 9. High side drivers 265 and 266 included in a rectifier circuit 200 of FIG. 4 are illustrated in FIG. 10. For example, the high side drivers 265 and 266 of the rectifier circuit 200 may include the high side driver 400 of FIG. 9.

The high side driver 265 generates a high side driving voltage Vd21 based on a rectified voltage Vrect, a voltage Vplus provided from an input node Nin1 (refer to FIG. 4), a voltage Vminus provided from an input node Nin2 (refer to FIG. 4), a bootstrap driving voltage VBD1, and a bootstrapping voltage Vb21. A node having the bootstrapping voltage Vb21 and the input node Nin1 are connected to each other.

The high side driver 265 includes the high side driver 400 of FIG. 9, as described with reference to FIG. 9. The bootstrap driving voltage VBD1 is provided as a driving voltage VDD1, the voltage Vminus provided from the input node Nin2 is provided as a driving voltage VDD2, the voltage Vplus provided from the input node Nin1 is provided as a first comparison target voltage Vt1, and the rectified voltage Vrect is provided as a second comparison target voltage Vt2. Further, the high side driving voltage Vd21 is outputted as an output voltage Vout. The high side driving voltage Vd21 is generated based on a comparison result of amplitude of the voltage Vplus provided from the input node Nin1 and the rectified voltage Vrect. A wire or line corresponding to a low side driving voltage Vc22 not being used to generate the high side driving voltage Vd21 need not be provided or may be floated. Alternatively, the high side driver 265 may further include a control circuit (not shown) for controlling a connection of wires or lines being used to generate the high side driving voltage Vd21 and a connection of the wire or line not being used to generate the high side driving voltage Vd21.

The high side driver 266 generates a high side driving voltage Vd22 based on the rectified voltage Vrect, the voltage Vplus provided from the input node Nin1, the voltage Vminus provided from the input node Nin2, the bootstrap driving voltage VBD1, and a bootstrapping voltage Vb22. A node having the bootstrapping voltage Vb22 and the input node Nin2 are connected to each other.

The high side driver 266 includes the high side driver 400 of FIG. 9, as described with reference to FIG. 9. The bootstrap driving voltage VBD1 is provided as a driving voltage VDD1. The voltage Vplus provided from the input node Nin1 is provided as a driving voltage VDD2. The voltage Vminus provided from the input node Nin2 is provided as a first comparison target voltage Vt1. The rectified voltage Vrect is provided as a second comparison target voltage Vt2. Further, the high side driving voltage Vd22 is outputted as an output voltage Vout. The high side driving voltage Vd22 is generated based on a comparison result of amplitude of the voltage Vminus provided from the input node Nin2 and the rectified voltage Vrect. A wire or line corresponding to a low side driving voltage Vc21 not being used to generate the high side driving voltage Vd22 need not be provided or may be floated. Alternatively, the high side driver 266 may further include a control circuit (not shown) for controlling a connection of wires or lines being used to generate the high side driving voltage Vd22 and a connection of the wire or line not being used to generate the high side driving voltage Vd22.

In the high side driver 400 described with reference to FIGS. 8 to 10, a level shifter 430 is controlled by a comparison signal CMP (refer to FIG. 8), which is generated by a current mode comparator 420. In this case, a response speed of the high side drivers 265 and 266 may become faster. When the high side drivers 265 and 266 of the rectifier circuit 200 include the high side driver 400 of FIGS. 8 and 9, the rectifier circuit 200 may have high conversion efficiency.

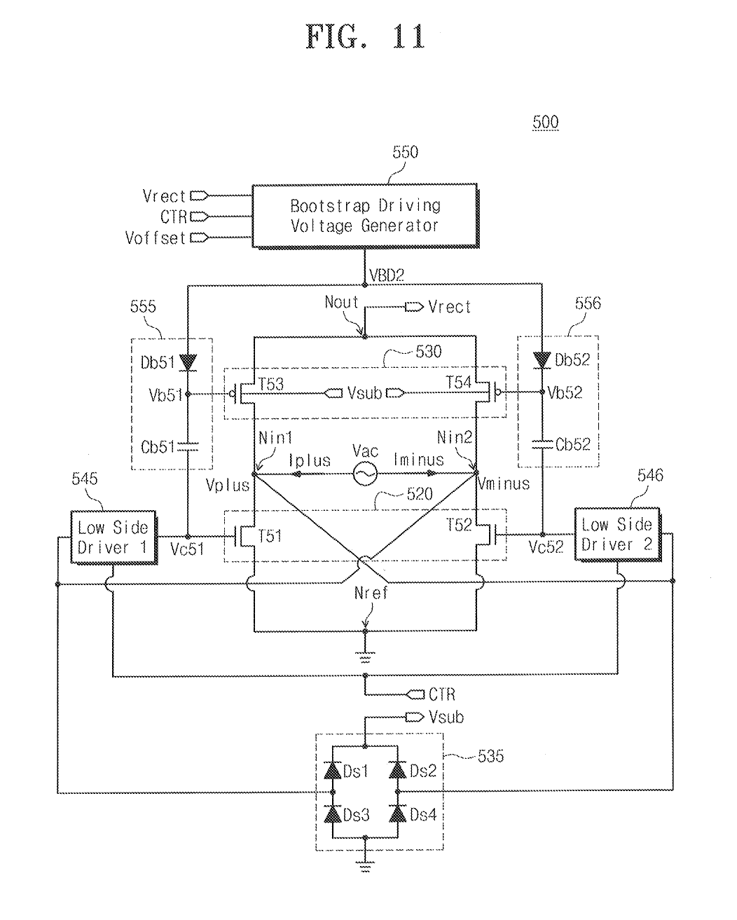

FIG. 11 is a schematic diagram illustrating a rectifier circuit 500 according to an exemplary embodiment of the present inventive concept. The rectifier circuit 500 receives an AC voltage Vac. The rectifier circuit 500 converts the received AC voltage Vac into a rectified voltage Vrect. The rectifier circuit 500 includes a low side switching circuit 520, a high side switching circuit 530, low side drivers 545 and 546, a bootstrap driving voltage generator 550, and bootstrap circuits 555 and 556.

Input currents Iplus and Iminus are generated based on the AC voltage Vac, and are provided to input nodes Nin1 and Nin2, respectively, of the rectifier circuit 500. For example, the input current Iplus is provided to the input node Nin1 based on a signal corresponding to a half period of the AC voltage Vac. Accordingly, the input node Nin1 has a voltage Vplus corresponding to the half period of the AC voltage Vac. Further, the input current Iminus is provided to the input node Nin2 based on the other half period of the AC voltage Vac. Accordingly, the input node Nin2 has a voltage Vminus corresponding to the other half period of the AC voltage Vac. A phase difference between the voltage Vplus and the voltage Vminus may be 180°. Descriptions of the voltages Vplus and Vminus of the input nodes Nin1 and Nin2 have been made with reference to FIG. 2.

The low side switching circuit 520 is connected between a reference node Nref and the input nodes Nin1 and Nin2. The reference node Vref is grounded, but the present inventive concept is not limited thereto. The low side switching circuit 520 includes low side transistors T51 and T52. The low side transistors T51 and T52 are an NMOS transistor. For example, one terminal of the low side transistor T51 is connected to the reference node Nref, and the other terminal of the low side transistor T52 is connected to the input node Nin1. One terminal of the low side transistor T52 is connected to the reference node Nref, and the other terminal of the low side transistor T52 is connected to the input node Nin2.

The high side switching circuit 530 is connected between the input nodes Nin1 and Nin2 and an output node Nout. The high side switching circuit 530 includes high side transistors T53 and T54. The high side transistors T53 and T54 are PMOS transistors. In this case, one terminal of the high side transistors T53 is connected to the output node Nout, and the other terminal of the high side transistors T53 is connected to the input node Nin1. One terminal of the high side transistors T54 is connected to the output node Nout, and the other terminal of the high side transistors T54 is connected to the input node Nin2.

As an example embodiment, the rectifier circuit 500 further include a substrate voltage generator 535. The substrate voltage generator 535 generate a substrate voltage Vsub. The substrate voltage Vsub are generated based on the voltage Vplus and Vminus provided from the input nodes Nin1 and Nin2. The substrate voltage Vsub is applied to the high side transistors T53 and T54 included in the high side switching circuit 530. The substrate voltage generator 535 includes four diodes Ds1, Ds2, Ds3, and Ds4. The configuration of the substrate voltage generator 535 illustrated in FIG. 11 is an exemplary embodiment, and the present inventive concept is not limited thereto.

The AC voltage Vac is converted into the rectified voltage Vrect by a circuit including the low side transistors T51 and T52 and the high side transistors T53 and T54. The rectified voltage Vrect is outputted from the output node Nout. For example, the low side switching circuit 520 is controlled by the low side drivers 545 and 546, and the high side switching circuit 530 is controlled by the bootstrap circuits 555 and 556.

The low side driver 545 receives the voltage Vminus of the input node Nin2 to output a low side driving voltage Vc51. The low side driving voltage Vc51 and the voltage Vminus of the input node Nin2 are synchronized in phase. The low side driving voltage Vc51 is provided to the low side switching circuit 520. The low side driver 545 operates in response to a control signal CTR. The control signal CTR has a voltage generated by a programmable linear regulator, but the present inventive concept is not limited thereto. The control signal CTR may have a fixed voltage value.

The low side driver 546 receives the voltage Vplus of the input node Nin1 to output a low side driving voltage Vc52. The low side driving voltage Vc52 and the voltage Vplus of the input node Nin1 are synchronized in phase. The low side driving voltage Vc52 is provided to the low side switching circuit 520. The low side driver 546 operates in response to the control signal CTR. Descriptions of waveforms of the low side driving voltages Vc51 and Vc52 have been made with reference to FIG. 3.

The low side switching circuit 520 includes the low side transistors T51 and T52. The low side driving voltage Vc51 is provided to a gate terminal of the low side transistor T51, and the low side driving voltage Vc52 is provided to a gate terminal of the low side transistor T52.

The bootstrap driving voltage generator 550 generates a bootstrap driving voltage VBD2. The bootstrap driving voltage VBD2 is generated based on the rectified voltage Vrect, a voltage corresponding to the control signal CTR, and an offset voltage Voffset. The offset voltage Voffset may be adjustable. A value of the bootstrap driving voltage VBD2 is adjusted by adjusting the value of the offset voltage Voffset. For example, the value of the bootstrap driving voltage VBD2 may be obtained by adding the value of the offset voltage Voffset to a value obtained by subtracting a value of the voltage corresponding to the control signal CTR from a value of the rectified voltage Vrect (i.e., VBD2=Vrect−CTR+Voffset). The present inventive concept is not limited thereto.

The bootstrap circuits 555 and 556 generate bootstrapping voltages Vb51 and Vb52. The bootstrap circuit 555 outputs the bootstrapping voltage Vb51, which is generated based on the bootstrap driving voltage VBD2 and the low side driving voltage Vc51. The bootstrapping voltage Vb51 is provided to the high side switching circuit 530. The high side switching circuit 530 includes the high side transistor T53. The bootstrapping voltage Vb51 is provided to a gate terminal of the high side transistor T53.

The bootstrap circuit 556 outputs the bootstrapping voltage Vb52, which is generated based on the bootstrap driving voltage VBD2 and the low side driving voltage Vc52. The bootstrapping voltage Vb52 is provided to the high side switching circuit 530. The high side switching circuit 530 includes the high side transistor T54. The bootstrapping voltage Vb52 is provided to a gate terminal of the high side transistor T54. Relations between the low side driving voltages Vc51 and Vc52 and the bootstrapping voltages Vb51 and Vb52 is similar to a relation between the low side driving voltage Vc21 and the high side driving voltage Vd21 illustrated in FIG. 5.

The bootstrap circuit 555 includes a diode Db51 and a capacitor Cb51. The diode Db51 and the capacitor Cb51 are connected in series between a node for receiving the bootstrap driving voltage VBD2 and a node having the low side driving voltage Vc51. For example, an anode of the diode Db51 is connected to the node for receiving the bootstrap driving voltage VBD2, and one terminal of the capacitor Cb51 is connected to the node having the low side driving voltage Vc51. Further, a cathode of the diode Db51 is connected to the other terminal of the capacitor Cb51. In this case, the bootstrapping voltage Vb51 is a voltage of a node at which the diode Db51 and the capacitor Cb51 are connected to each other.

The bootstrap circuit 556 includes a diode Db52 and a capacitor Cb52. The diode Db52 and the capacitor Cb52 are connected in series between the node for receiving the bootstrap drive voltage VBD2 and a node having the low side driving voltage Vc52. In particular, an anode of the diode Db52 is connected to the node for receiving the bootstrap drive voltage VBD2, and one terminal of the capacitor Cb52 is connected to the node having the low side driving voltage Vc52. Further, a cathode of the diode Db52 is connected to the other terminal of the capacitor Cb52. In this example embodiment, the bootstrapping voltage Vb52 is a voltage of a node at which the diode Db52 and the capacitor Cb52 are connected to each other.

In FIG. 11, power loss due to a switching may be reduced. Further, the rectifier circuit 500 may process a signal having a high frequency of more than several MHz. According to an exemplary embodiment of the present inventive concept, a rectifier circuit having high conversion efficiency may be obtained. Moreover, the rectifier circuit 500 illustrated in FIG. 11 does not include drivers for controlling the high side transistors T53 and T54. Thus, an area occupied by the rectifier circuit 500 may be reduced, and the rectifier circuit 500 may have a high response speed. Furthermore, the value of the offset voltage Voffset may be adjustable to adjust the rectified voltage of the rectifier circuit 500.

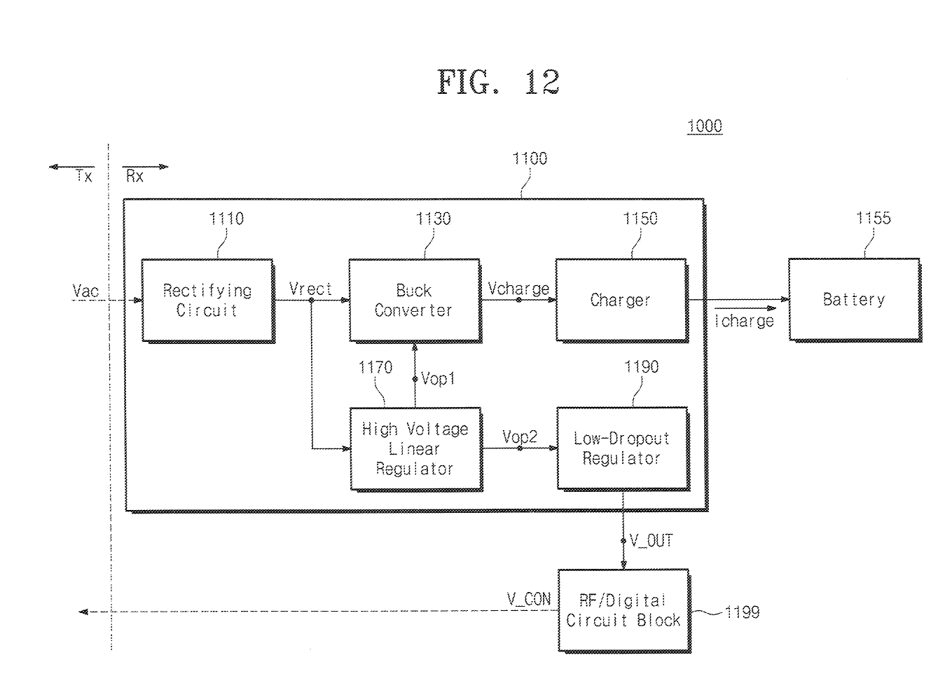

FIG. 12 is a block diagram illustrating a receiver Rx of a power transferring system 1000 including a rectifier circuit 1110 according to an exemplary embodiment of the present inventive concept. The receiver Rx of the power transfer system 1000 includes a power transferring device 1100, a battery 1155, and a radio frequency (RF)/digital circuit block 1199. The power transferring device 1100 includes the rectifier circuit 1110, a buck converter 1130, a charger 1150, a high voltage linear regulator 1170, and low-dropout (LDO) regulator 1190.

For the convenience of description, it is assumed that the power transferring system 1000 is a wireless charging system using a magnetic resonance between inductive elements. The power transferring system 1000 be applicable to other types of systems.

The rectifier circuit 1110 receives an AC voltage Vac from a transmitter Tx of the power transferring system 1000. The rectifier circuit 1110 rectifies the received AC voltage Vac. For example, the rectifier circuit 1110 converts the received AC voltage Vac into a rectified voltage Vrect. The configuration of the rectifier circuit 1110 is described with reference to FIGS. 1 to 11, thus, the redundant descriptions of the rectifier circuit 1110 will be omitted.

The buck converter 1130 receives the rectified voltage Vrect. The buck converter 1130 operates by using a first operation voltage Vop1 generated by the high voltage linear regulator 1170. The buck converter 1130 outputs a charging voltage Vcharge based on the rectified voltage Vrect. The buck converter 1130 converts the rectified voltage Vrect having a fluctuating value into the charging voltage Vcharge having a relatively stable value.

The charger 1150 generates charging current Icharge based on the charging voltage Vcharge. The charging current Icharge is provided to the battery 1155. The amount of charges charged in the battery 1150 increases by increasing the charging current Icharge.

The high voltage linear regulator 1170 receives the rectified voltage Vrect. The high voltage linear regulator 1170 generates the first operation voltage Vop1 for operating the buck converter 11130 based on the rectified voltage Vrect. Further, the high voltage linear regulator 1170 generates a second operation voltage Vop2 for operating the LDO regulator 1190 based on the rectified voltage Vrect.

The high voltage linear regulator 1170 serves as a power supply device for operating the power transferring device 1100. For example, the high voltage linear regulator 1170 converts the rectified voltage Vrect having a fluctuating value into the first and second operation voltages Vop1 and Vop2 having a relatively stable value.

The LDO regulator 1190 operates by using the second operation voltage Vop2 generated by the high voltage linear regulator 1170. The low-dropout regulator 1190 outputs an output voltage V_OUT based on the second operation voltage Vop2. The output voltage V_OUT generated by the LDO regulator 1190 is provided to the RF/digital circuit block 1199.

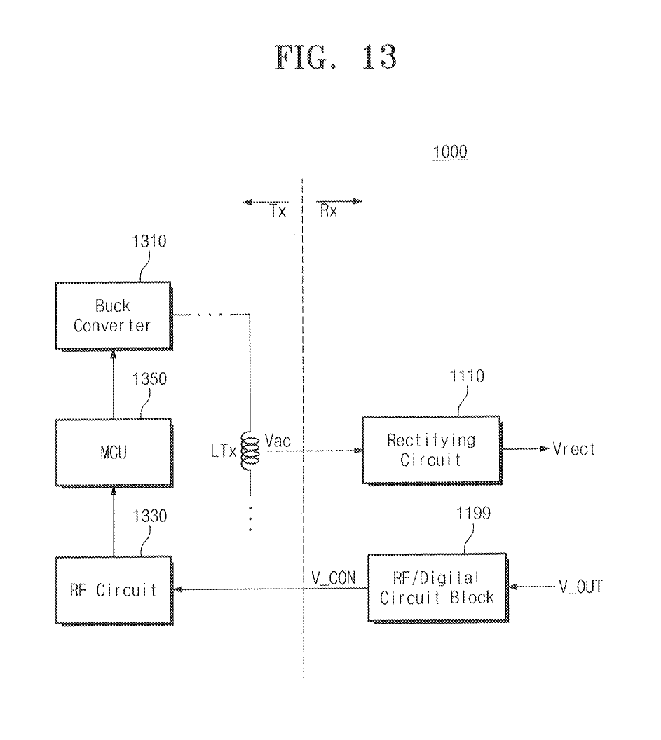

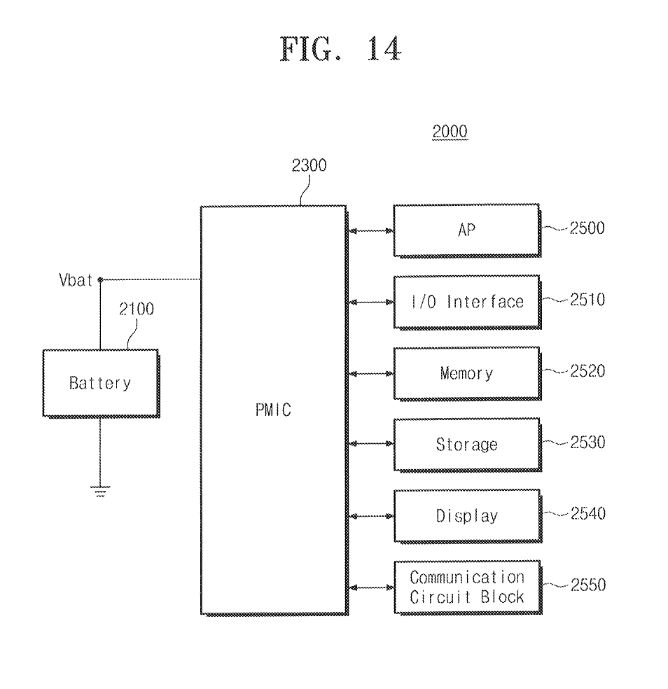

The RF/digital circuit block 1199 operates by using the output voltage V_OUT. The RF/digital circuit block 1199 transmits a voltage control signal V_CON to the transmitter Tx of the power transferring system 1000. Descriptions of the voltage control signal V_CON will be made with reference to FIG. 13.

FIG. 13 is a block diagram illustrating a transmitter Tx and a receiver Rx of a power transferring system 1000 including a rectifier circuit 1110 according to an exemplary embodiment of the present inventive concept. For the convenience of description, it is assumed that the power transferring system 1000 of FIG. 13 is a wireless charging system using a magnetic resonance between inductive elements. A transmitter Tx of the power transfer system 1000 includes a buck converter 1310, an RF circuit 1330, a micro control unit (MCU) 1350, and a transmitting inductor LTx. For the convenience of description, the receiver Rx is shown to include the rectifier circuit 1110 and a RF/digital circuit block 1199. The transmitter Tx and the receiver Rx of the power transferring system 1000 may further include other components other than the components illustrated in FIG. 13.

The buck converter 1310 of the transmitter Tx transfers power to the transmitting inductor LTx. The rectifier circuit 1110 receives an AC voltage Vac from the transmitting inductor LTx by magnetic resonance. The rectifier circuit 1100 rectifies the received AC voltage Vac. For example, the rectifier circuit 1100 converts the received AC voltage Vac into the rectified voltage Vrect. The rectifier circuit 1110 may be configured according to an exemplary embodiment of the present inventive concept. For example, the rectifier circuit 110 may be configured according to the exemplary embodiments of FIGS. 1 to 11. The redundant descriptions associated with configurations and operations of the rectifier circuit 1110 will be omitted. As described with reference to FIG. 12, the rectified voltage Vrect is converted into an output voltage V_OUT through a high voltage linear regulator 1170 (refer to FIG. 12) and a LDO regulator 1190 (refer to FIG. 12).

The RF/digital circuit block 1199 operates by using the output voltage V_OUT. The RF/digital circuit block 1199 transmits a voltage control signal V_CON to the RF circuit 1330 of the transmitter Tx. The voltage control signal V_CON is a signal for controlling amplitude of the AC voltage Vac being provided to the rectifier circuit 1110. By controlling amplitude of the AC voltage Vac based on the voltage control signal V_CON, amplitude of a voltage being provided to components included in the receiver Rx of the power transferring system 1000 is adjusted.

The voltage control signal V_CON is provided to the MCU 1350 through the RF circuit 1330. The MCU 1350 controls the buck converter 1310 based on the voltage control signal V_CON. The buck converter 1310 adjusts amplitude of power being transferred to the transmitting inductor LTx according to a control of the MCU 1350. As a result, amplitude of the AC voltage Vac being provided to the rectifier circuit 1110 is adjusted.

FIG. 14 is a block diagram illustrating a power management system 2000 of a portable electronic device employing a power transferring system 1000 including a rectifier circuit according to an exemplary embodiment of the present inventive concept. A power management system 2000 includes a battery 2100, a power management integrated circuit (PMIC) 2300, an application processor (AP) 2500, an input/output interface 2510, a memory 2520, a storage 2530, a display 2540, and a communication circuit block 2550. However, the present inventive concept is not limited thereto. For example, the power management system 2000 and the portable electronic device including the same may further include components other than the components illustrated in FIG. 14. Alternatively, the power management system 2000 and the portable electronic device including the same may include less components than those of FIG. 14.

The battery 2100 is charged by using charging current Icharge. When the battery 2100 is connected to the portable electronic device after being charged, the battery 2100 outputs a battery voltage Vbat. The battery voltage Vbat is provided to the PMIC 2300. The PMIC 2300 converts the battery voltage Vbat provided from the battery 2100 into a stable voltage. The PMIC 2300 provides the stable voltage to other components. Each of the AP 2500, the input/output interface 2510, the memory 2520, the storage 2530, the display 2540, and the communication circuit block 2550 operates by using the stable voltage provided from the PMIC 2300.

While the present inventive concept has been shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A rectifier circuit comprising:
a low side switching circuit connected between a reference node and first and second input nodes, wherein the first and second input nodes receive an alternating current (AC) voltage;
a high side switching circuit connected between an output node and the first and second input nodes, wherein the output node outputs a rectified voltage of the AC voltage; and
a low side driver coupled to the low side switching circuit, wherein the low side driver is configured to control, in response to a control signal, the low side switching circuit so that the low side driving voltage and a voltage provided from one of the first and second input nodes are synchronized in phase.

2. The rectifier circuit of claim 1, wherein the high side switching circuit comprises a diode, and
wherein an anode of the diode is connected to the first input node and a cathode of the diode is connected to the output node.

3. The rectifier circuit of claim 1, wherein the low side switching circuit comprises a switching transistor and a diode connected in parallel between the reference node and the first input node.

4. The rectifier circuit of claim 3, wherein a gate terminal of the switching transistor is coupled to the low side driver, receiving the low side driving voltage.

5. A rectifier circuit comprising:
a low side switching circuit connected between a reference node and first and second input nodes, wherein the first and second input nodes receive an alternating current (AC) voltage;
a high side switching circuit connected between an output node and the first and second input nodes, wherein the output node outputs a rectified voltage of the AC voltage;
first and second low side drivers, each being coupled to the low side switching circuit, wherein the first and second low side drivers are configured to generate low side driving voltages, and wherein the first and second low side drivers are configured to control, in response to a control signal, the low side switching circuit so that the low side driving voltages provided from the first and second low side drivers are synchronized with voltages provided from the second and first input nodes, respectively;
a bootstrap circuit coupled to the second input node, wherein the bootstrap circuit is configured to generate a bootstrapping voltage based on a bootstrap driving voltage and the voltage provided from the second input node; and
a high side driver coupled to the high side switching circuit, wherein the high side driver is configured to provide a high side driving voltage to the high side switching circuit to control the high side switching circuit and generate the high side driving voltage based on at least one of the rectified voltage, the voltages provided from the first and second input nodes, the low side driving voltage generated by the second low side driver, the bootstrap driving voltage, and the bootstrapping voltage.

6. The rectifier circuit of claim 5, wherein high side driving voltage is greater than the low side driving voltage by the bootstrap driving voltage.

7. The rectifier circuit of claim 5, wherein the bootstrap circuit comprises a diode and a capacitor
connected in series between a node where the bootstrap driving voltage is applied and the second input node, and
wherein the bootstrapping voltage is outputted from a node at which the diode and the capacitor are connected to each other.

8. The rectifier circuit of claim 7, wherein an anode of the diode is connected to the node where the bootstrap driving voltage is applied,
wherein one terminal of the capacitor is connected to the second input node, and
wherein a cathode of the diode is connected to another terminal of the capacitor.

9. The rectifier circuit of claim 5, wherein the low side switching circuit comprises a low side transistor, one terminal of the low side transistor being connected to the reference node, another terminal of the low side transistor being connected to the first input node, and
wherein the high side switching circuit comprises a high side transistor, one terminal of the high side transistor being connected to the first input node, another terminal of the high side transistor being connected to the output node.

10. The rectifier circuit of claim 9, wherein a gate terminal of the low side transistor is coupled to the first low side driver, receiving the low side driving voltage from the first low side driver, and
wherein a gate terminal of the high side transistor is coupled to the high side driver, receiving the high side driving voltage from the high side driver.

11. The rectifier circuit of claim 9, wherein the high side driver comprises:
a level shifter configured to generate the high side driving voltage based on the voltage provided from the first input node, the low side driving voltage, and the bootstrapping voltage;
a latch circuit configured to latch the high side driving voltage;
a pull-up signal generator configured to generate a pull-up signal based on the high side driving voltage and the latched high side driving voltage; and
a pull-up circuit configured to control the level shifter so that the level shifter generates, in response to the pull-up signal, the high side driving voltage.

12. The rectifier circuit of claim 9, wherein the high side driver comprises:
a bias current generator configured to receive the bootstrap driving voltage to generate a bias current;
a current mode comparator configured to generate a comparison signal based on an amplitude comparison result of the voltage provided from the first input node and the rectified voltage, by using the generated bias current; and
a level shifter configured to generate an intermediate signal, based on the generated comparison signal.

13. The rectifier circuit of claim 12, wherein the bias current generator comprises a first-type first current mirror configured to provide the bias current to the current mode comparator.

14. The rectifier circuit of claim 13, wherein the current mode comparator comprises:
a second-type first current mirror configured to output current provided from the first-type first current mirror, by using the rectified voltage;
a first-type second current mirror configured to output current provided from the second-type first current mirror;
a second-type second current mirror configured to output current provided from the first-type second current mirror, by using the voltage provided from the first input node; and
a first-type third current mirror configured to output current provided from the second-type second current mirror,
wherein the comparison signal is generated based on the current outputted from the second-type first current mirror and current outputted from the first-type third current mirror.

15. The rectifier circuit of claim 14, wherein the level shifter comprises:
a first-type fourth current mirror coupled to the second-type first current mirror;
a comparison control transistor coupled to the first-type fourth current mirror, wherein a gate terminal of the comparison control transistor receives the comparison signal;
a second-type third current mirror coupled between the comparison control transistor and the second input node;
a second-type fourth current mirror coupled between the first-type fourth current mirror and the second input node; and
a first-type fifth current mirror coupled between the second-type fourth current mirror and the first input node,
wherein the intermediate signal is generated based on current outputted from the second-type third current mirror and current outputted from the first-type fifth current mirror.

16. The rectifier circuit of claim 15, wherein each of the first-type first current mirror, the first-type second current mirror, the first-type third current mirror, the first-type fourth current mirror, and the first-type fifth current mirror is an n-channel metal oxide semiconductor (NMOS) type current mirror, and
wherein each of the second-type first current mirror, the second-type second current mirror, the second-type third current mirror, and the second-type fourth current mirror is a p-channel metal oxide semiconductor (PMOS) type current mirror.

17. The rectifier circuit of claim 12, wherein the high side driver further comprises:
an inverter configured to invert the intermediate signal; and
an output circuit configured to output the inverted intermediate signal as the high side driving voltage.

18. A rectifier circuit comprising:
a low side switching circuit connected between a reference node and first and second input nodes, wherein the first and second input nodes receive an alternating current (AC) voltage;
a high side switching circuit connected between an output node and the first and second input nodes, wherein the output node outputs a rectified voltage of the AC voltage;
first and second low side drivers, each being coupled to the low side switching circuit, wherein the first and second low side drivers are configured to generate low side driving voltages, and wherein the first and second low side drivers are configured to control, in response to a control signal, the low side switching circuit so that the low side driving voltages provided from the first and second low side drivers are synchronized with voltages provided from the second and first input nodes, respectively;
a bootstrap driving voltage generator configured to generate a bootstrap driving voltage based on the rectified voltage, the control signal, and an offset voltage; and
a bootstrap circuit coupled to the high side switching circuit, wherein the bootstrap circuit is configured to generate a bootstrapping voltage based on the low side driving voltage generated by the first low side driver and the bootstrap driving voltage and provide the bootstrapping voltage to the high side switching circuit.

19. The rectifier circuit of claim 18, further comprising a substrate voltage generator configured to generate a substrate voltage applied to a substrate of a high side transistor included in the high side switching circuit, by using the voltages provided from the first and second input nodes.

20. The rectifier circuit of claim 18, wherein a value of the offset voltage is adjustable, and
wherein a value of the generated bootstrap driving voltage corresponds to a value obtained by adding the value of the offset voltage to a value obtained by subtracting a value of the voltage corresponding to the control signal from a value of the rectified voltage.
